(19) United States
(12) Patent Application Publication
(10) Pub. No.: US 2025/0268376 A1
(43) Pub. Date: Aug. 28, 2025

(54) ARRANGEMENT OF A TIPPING-OVER-PREVENTION OF A CHEST OF DRAWERS, AND A CHEST OF DRAWERS USING SUCH ARRANGEMENT

(71) Applicant: Inter IKEA Systems B.V., LN DELFT (NL)

(72) Inventors: Magnus SVENSSON, Lönsboda (SE); Erik Bergqvist, Malmö (SE)

(73) Assignee: Inter IKEA Systems B.V., LN DELFT (NL)

(21) Appl. No.: 19/065,648

(22) Filed: Feb. 27, 2025

(30) Foreign Application Priority Data
Feb. 28, 2024 (SE) 2450237-9

(51) Int. Cl. A47B 88/427; A47B 97/00

(52) U.S. Cl. CPC A47B 88/427; A47B 97/00; A47B 2097/008

(57) ABSTRACT

An arrangement for tipping-over-prevention is provided for of a chest of drawers that may include a partition wall separating two columns of drawers. The arrangement may include a first drawer locking arrangement having a first guiding rail to be movably mounted to the partition wall, and a second drawer locking arrangement having a second guiding rail to be movably mounted to the partition wall. The first and second guiding rails may support at least two locking members that are configured to selectively engage an associated drawer and allow only one drawer in a column to be opened at a time. A connector arrangement may interconnect the first and second guiding rails via a through-going opening in the partition wall, whereby the first and second guiding rails are moveable as one common unit relative to the partition wall. Also, a chest of drawers including such arrangement is provided.

This application claims priority under 35 USC 119 (a)-(d) from Swedish patent application No. 2450237-9 filed Feb. 28, 2024, the entire contents of which are incorporated herein by reference.

### BACKGROUND

### 1. Technical Field

Non-limiting embodiments relate to an arrangement of a tipping-over-prevention of a chest of drawers, and a chest of drawers comprising such arrangement.

### 2. Discussion of Related Art

A chest of drawers is a classical piece of furniture to store items in homes. The width and depth respectively of the chest of drawers is typically substantially smaller than the height. Thereby a large storing capacity is provided for while only requiring a limited footprint. Each drawer defines a storing volume and as a drawer is opened, the center of mass will be displaced. This is in most cases never a problem since the underlying working principle of a chest of drawers is to pull out drawers to get access to the contents. It is however never possible to foresee how a piece of furniture is used in practice and in the worst-case scenario, the chest of drawers may tip over and cause severe personal injuries. Typical risks are when the drawers at a higher level are filled with a heavy load and opened, or when a person is leaning over or seeks support against the chest or a pulled-out drawer. The latter may especially be the case when children are using the chest of drawers, either when trying to get access to its contents by climbing, or simply playing around.

As a safety measure it is well known to use brackets of different types to fixate the chest of drawers against a wall to thereby safeguard against any tipping over. However, even though the chest of drawers is delivered with brackets and the manual explicitly prescribe that the brackets should be mounted before taking the chest of drawers into use, the user frequently decides not to mount the brackets.

There are also solutions which prevent that more than one drawer is opened at a time. One such solution is disclosed in U.S. Pat. No. 4,768,844. In this locking system, each drawer is provided with an actuator pin, and also each drawer is configured, via a respective pivotable cam mechanism interacting with the actuator pin, to cause a longitudinal displacement of a respective locking bar which is received in a common guiding channel in a wall portion of the chest. The displacement of the one or more locking bars cause a compression of a common spring which is received in a gap having a fixed length. The fixed length of the gap is chosen to allow the displacement of one locking bar which displacement is required to open one drawer and which displacement is the result of the pivoting of one single drawer's cam mechanism. Thereby only one drawer at the time may be opened. As a result of the fixed length of the gap, the system has an inherent mechanical restriction that prevents two or more drawers from being opened at the same time.

It is however important from a user perspective that she can use the chest of drawers according to her own needs without being restricted to open one drawer at a time. From a safety perspective this must be made in a safe manner without the chest tipping over. From this aspect, it is known to combine the above described locking system with a wall bracket, where the wall bracket, when fixated to a wall to anchor the chest of drawers, also sets aside the restrictions provided for by the locking system. This does however require one wall bracket per locking system. This is typically no problem when the chest of drawers comprises one or two vertical columns of drawers since either one or two sets of wall brackets and locking systems will be required depending on one or two columns. However, it is also common that a chest of drawers may have more than two columns of drawers. That requires with prior art two or more wall brackets and hence more holes to be formed in the wall. The latter is less appealing to the house or flat owner. The number of wall brackets also has a negative impact on the overall cost of the chest of drawers.

There is hence a need to provide an arrangement of a tipping-over-prevention that can be implemented in a chest of drawers having more than one column of drawers, which arrangement maintains the same degree of safety and ease of use.

### SUMMARY

An object of the present invention is to provide an arrangement of a tipping-over-prevention that can be implemented in a chest of drawers having two or more columns of drawers and which at least partly overcome the drawbacks and risks mentioned above.

According to a first aspect, these and other objects are provided for by an arrangement for tipping-over-prevention of a chest of drawers comprising a partition wall separating two columns of drawers, wherein the arrangement may comprise a first drawer locking arrangement comprising a first guiding rail configured to be movably mounted to a first side of the partition wall, and a second drawer locking arrangement comprising a second guiding rail configured to be movably mounted to a second side of the partition wall, opposite the first side. The arrangement may further comprise a plurality of locking members, where each of the first and the second guiding rails supports at least two locking members, each locking member being configured to selectively engage an associated drawer and selectively allow only one drawer in a column to be opened at a time. Yet further the arrangement may comprise a connector arrangement configured to interconnect the first and the second guiding rails via a through-going opening in the partition wall, whereby the first and second guiding rails are configured to be moved as one common unit in view of the partition wall.

According to a second aspect, an arrangement for tipping-over-prevention of a chest of drawers that includes a partition wall separating two columns of drawers is provided. The arrangement may comprise a first guiding rail movably mounted to a first side of the partition wall, and a second guiding rail movably mounted to a second side of the partition wall. Each of the first and the second guiding rails supports a plurality of locking members that are respectively engageable with associated drawers. The first and the second guiding rails are movable relative to the partition wall between a first lowered position in which all of the locking members are respectively engaged with the associated drawers in a closed condition, and a second elevated position in which all of the locking members are respectively disengaged from the associated drawers in the closed condition.

The arrangement may further comprise a connector arrangement interconnecting the first and the second guiding rails via a through-going opening in the partition wall, such that the first and the second guiding rails are movable as one common unit relative to the partition wall.

According to a third aspect, an arrangement for tipping-over-prevention of a chest of drawers that includes a partition wall separating two columns of drawers is provided. The arrangement may comprise a first guiding rail movably mounted to a first side of the partition wall and a second guiding rail movably mounted to a second side of the partition wall. Each of the first and the second guiding rails supports a plurality of locking members that are respectively engageable with associated drawers. The first and the second guiding rails are interconnected and movable relative to the partition wall between a first position in which only one drawer of each column of drawers at the time is allowed to open, and a second position in which any number of drawers of each column of drawers at the time are allowed to be open.

Accordingly, an arrangement for tipping-over-prevention is provided that is designed for a chest of drawers with two or more columns of drawers where the two or more columns are separated by a partition wall. Each column is provided with a drawer locking arrangement that, by the use of at least two locking members in each locking arrangement selectively allows only one drawer in a column to be opened at a time. The connector arrangement that interconnects the first and second guiding rails implies that the two guiding rails may be moved as one common unit. This allows the arrangement for tipping-over-prevention to be operated by one single mechanism that moves the guiding rails and hence the locking members supported by the guiding rails as one unit. By moving the guiding rails, the locking members will be moved along. The locking members may thereby be moved to a position in which the locking members in the two adjacent columns no longer can engage an associated drawer and prevent opening thereof. Hence, in such position, any number of drawers in the chest of drawers may be freely opened.

The movement may be made by a lifting movement that is allowed by the two guiding rails being slidingly received in a respective groove in the partition wall.

The connector arrangement may in a very simple and straight-forward solution be provided by a bolt and nut arrangement.

The mechanism that moves the guiding rails may be an anchoring bracket that is used to anchor the chest of drawers to a separate structure, such as a wall in a building or another piece of furniture.

The term chest of drawers is intended to include furnitures of the type having drawers and where the center of gravity may be changed during use by opening/closing the drawers. Non-limiting examples are chest of drawers for domestic use, office furniture and file cabinets.

In the following, a number of preferred embodiments will be listed. These preferred embodiments are applicable for each one of the first, second, and third aspects described above. Further, the preferred embodiments listed below may be combined in any combination, and for every aspect.

Each locking member may be pivotally supported on the associated guiding rail. This allows for a simple mounting of the locking members, still allowing for the desired functionality of the locking members.

Each locking member may comprise a gap configured to receive an actuator pin of an associated drawer. This ensures a very robust and reliable engagement and disengagement of the drawer to the guiding rail/locking member.

Each locking member may be pivotable between a first position, in which the actuator pin is held in place by said gap, and a second position, in which the actuator pin is free to move away from said gap. This provides for a robust, yet simple implementation of allowing only one drawer at the time to open.

The arrangement may further comprise at least one rod being configured to move between an idle position, in which each locking member is allowed to pivot from the first position to the second position, and a lifted position, in which each locking member is prevented to pivot from the first position to the second position. This also provides for a simple yet reliable implementation of allowing only one drawer at the time to open.

A first locking member pivoting from the first position to the second position may cause the at least one rod to move from the idle position to the lifted position. Hence, opening of a first drawer will automatically prevent opening of additional drawers until the first drawer is closed.

The connector arrangement may comprise a first connector member configured to be mounted to the first guiding rail and a second connector member configured to be mounted to the second guiding rail, wherein one or both of the first and second connector members comprises a protrusion configured to engage the other of the first and second connector members.

The first and the second connector members together form a driver that forces the two guiding rails to be moved as one single unit although the guiding rails are arranged on opposite sides of the partition wall.

The protrusions in the first and second connector members preferably have an extension perpendicular to a major extension plane of the partition wall.

A free end of the protrusion of the first connector member may be configured to engage a recess in the second connector member, and a free end of the protrusion of the second connector member may be configured to engage a recess in the first connector member.

The protrusions and recesses in the first and second connector members preferably have an extension perpendicular to a major extension plane of the partition wall.

The combination of recesses and protrusions allows a very simple and durable interlocking between the two locking arrangements since the locking engagement may be provided for by a strict linear movement of the two guiding rails from opposite sides of the partition wall and perpendicularly thereto. This linear movement is perpendicular to the intended movement direction of the guiding rails. Hence, a contact surface will be formed between the protrusions and their respective recesses, which contact surface extends substantially perpendicular to the movement direction of the guiding rails, whereby there is no risk of unintentional separation during ordinary use of the arrangement for tipping-over-prevention.

No separate fixing members such as screws and brackets are required.

The protrusions of the first and second connector members may each comprises an abutment surface, where the abutment surfaces are configured to abut each other in a condition when the free end of the first protrusion of the first connector member engages the recess in the second connector member and when the free end of the second protrusion of the second connector member engages the recess in the first connector member.

The abutment surfaces may be flat. It is also to be understood that the abutment surfaces may be provided with friction means or linear guiding means. Any linear guiding means may be configured to extend perpendicular to a major extension plane of the partition wall.

The recesses in the first and second connector members may have a wedge-shaped cross section as seen in a direction transverse a longitudinal extension of the respective guiding rails. Alternatively, the first and second protrusions may each have a wedge-shaped cross section as seen in a direction transverse the longitudinal extension of the respective guiding rails.

A wedge shape, no matter if it is the recesses of the protrusions, provides an enhanced locking effect between the first and second guiding rails.

The recesses in the first and second connector members may each comprise a wall portion having an extension transverse the longitudinal extension of the first and second guiding rails. The wall portion serves as a natural stop and hence as an anvil as seen in the height direction of the piece of furniture (typical vertical direction) in the event the recess should have a height that exceeds the height of the protrusion.

The first and second connector members may be configured to be mounted to the respective guiding rail by a snap-fit coupling. This allows the connector members to be mounted without the need for any separate fixing means or tools.

A snap-fit coupling may be arranged in a number of ways with remained function. The connector member may by way of example be provided with a plug that is configured to be received in a hole in the guide rail.

The first and second connector members may be rotationally fixed to the respective guiding rail. This allows a more robust mounting which also better resists the forces that may be applicable during the lifetime of the piece of furniture.

The arrangement may further comprise an anchoring bracket, and the first guiding rail may comprise a driver configured to engage the anchoring bracket; wherein a mounting of the anchoring bracket to a wall structure is configured to move the first and the second guiding rails concurrently as one unit from a first position in which the at least two locking members of the first and second drawer locking arrangements are set to allow opening of one drawer per column only, into a second position in which the at least two locking members of the first and second drawer locking arrangements are set in a position in which all drawers in both columns are allowed to be selectively opened.

Accordingly, by combing the above disclosed arrangement for tipping-over-prevention with an anchoring bracket, the further effect is provided that in a condition when the chest of drawers is anchored to a wall or another structure, the drawer locking arrangement is set from an active mode to a passive mode. When the drawer locking arrangement is set into the active mode, i.e., when the anchoring bracket is not anchored to a wall or another structure, only one drawer in each column is allowed to be selectively opened at a time. The user may freely choose which drawer, but only one drawer in a column may be opened or be open at a time. When set into the passive mode, i.e., when the anchoring bracket is anchored to a wall or another structure, the user is allowed to selectively open any drawer and any number of drawers at the same time.

By the connector arrangement, it is sufficient with one single anchoring bracket to serve drawers in two adjacent columns. This should be compared with a solution according to prior art using the same type of guiding rails with locking members where each column requires its own anchoring bracket.

The driver may be configured to move the guiding rails from the first position, in which the locking members engage with the associated drawers, to the second position, in which the locking members are disengaged from the associated drawers. This allows a single motion to effectively cause each of the locking members to disengage from the associated drivers, thereby overriding the default functionality of allowing only one drawer at the time to open.

The anchoring bracket may comprise a first bracket member which is adapted to be mounted to the partition wall of the chest of drawers and a second bracket member which is operatively engaging the driver and which is movable in relation to the first bracket member between a first position and a second position, in which second position the second bracket member is adapted to be fixedly anchored to a structure separate from the chest of drawers, wherein
when the second bracket member is in its first position, the driver is set to a first driver position in which the at least two locking members of the first and second drawer locking arrangements are set to allow opening of one drawer per column only, and
when the second bracket member is in its second position, the driver is set into a second driver position in which the at least two locking members of the first and second drawer locking arrangements are set in a position in which all drawers are allowed to be selectively opened.

The arrangement is very easy to use since the only measure required is to anchor the second bracket member of the anchoring bracket to a structure separate from the chest of drawers, such as a wall in a building or another furniture. This may be made by any suitable fixing element such as a screw or a bolt. The fixing element may be mounted by a strict linear movement perpendicular to the structural part. During such anchoring, the drawer locking arrangement will automatically be set into its passive mode while at the same time the chest of drawers is prevented from tipping over. Correspondingly, when removing the fixing element, e.g. during a move, the drawer locking arrangement will automatically be re-set into its active mode where only one drawer at a time may be open or be opened.

All parts of the arrangement, except for the fixing element, may be pre-mounted to the chest of drawers. Thereby the risk of losing relevant parts over time, such as during a move, is eliminated. The chest of drawers will thereby maintain its tipping-over-prevention feature and allow it to be fully used also on the second-hand market. Further, its operation is very intuitive, whereby the need for a user manual is reduced/eliminated.

The arrangement for tipping-over-prevention has been exemplified as being applied to a chest of drawers. It is to be understood that the arrangement is equally applicable to other types of furniture with drawers where the center of gravity may be changed during use. Non-limiting examples are office furniture and file cabinets.

According to yet another aspect, a chest of drawers comprising a partition wall separating two columns of drawers, which comprises an arrangement for tipping-over-prevention as presented above, may be provided.

The arrangement for tipping-over-prevention, with its features, functionality and advantages have been thoroughly discussed above. It will be appreciated that these features, functionalities and advantages are equally applicable to a chest of drawer using such arrangement. Reference is made to the sections above to avoid undue repetition.

The chest of drawers may in one embodiment further comprise an anchoring bracket of the type described above, with the anchoring bracket being configured to set the drawer locking arrangement into a passive mode when the chest of drawers is anchored to a wall by using the anchoring bracket, in which passive mode a user is allowed to selectively open any drawer and any number of drawers at the same time.

Further objects and advantages of the present invention will be obvious to a person skilled in the art reading the detailed description given below describing different embodiments.

### BRIEF DESCRIPTION OF THE DRAWINGS

Non-limiting embodiments will become more fully understood from the detailed description below and the accompanying drawings, wherein like elements are represented by like reference numerals, which are given by way of illustration only and thus are not limiting of the present invention.

FIG. 1 discloses one example of a chest of drawers with two columns of drawers where the two columns are separated by a partition wall.

FIG. 2 is a perspective view of one example of a partition wall.

FIG. 3 is a schematic exploded view of a chest of drawers comprising an arrangement for tipping-over-prevention.

FIGS. 4a-4d schematically discloses the mounting of a coupling member to a guiding rail.

FIGS. 5a-5c schematically discloses the engagement between a first and a second coupling member.

FIG. 6 schematically discloses a partition wall with an arrangement for tipping-over-prevention.

FIGS. 7a-7f schematically discloses the operation of the arrangement for tipping-over-prevention when interacting with an anchoring bracket.

### DESCRIPTION OF NON-LIMITING EMBODIMENTS

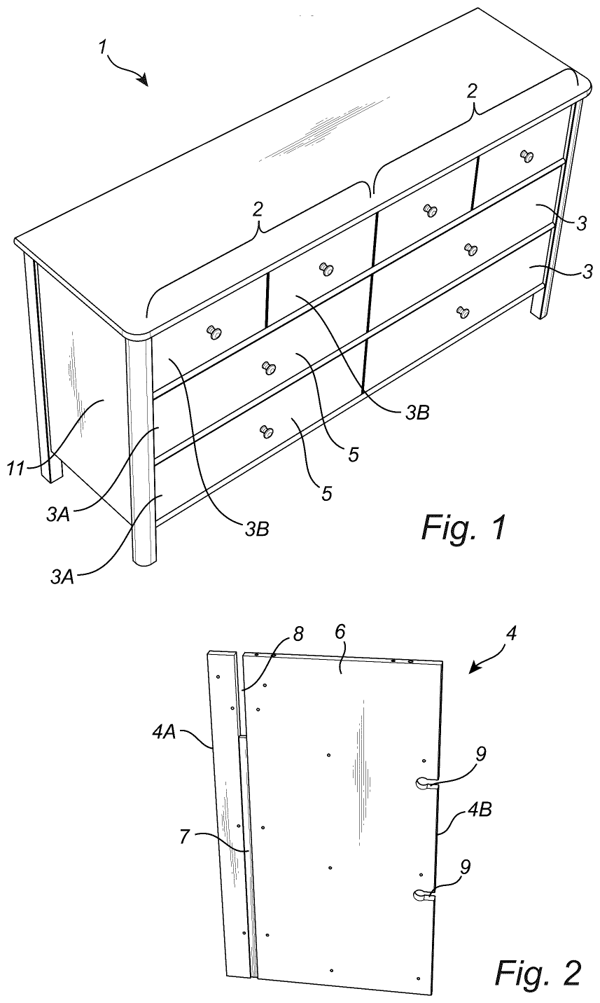

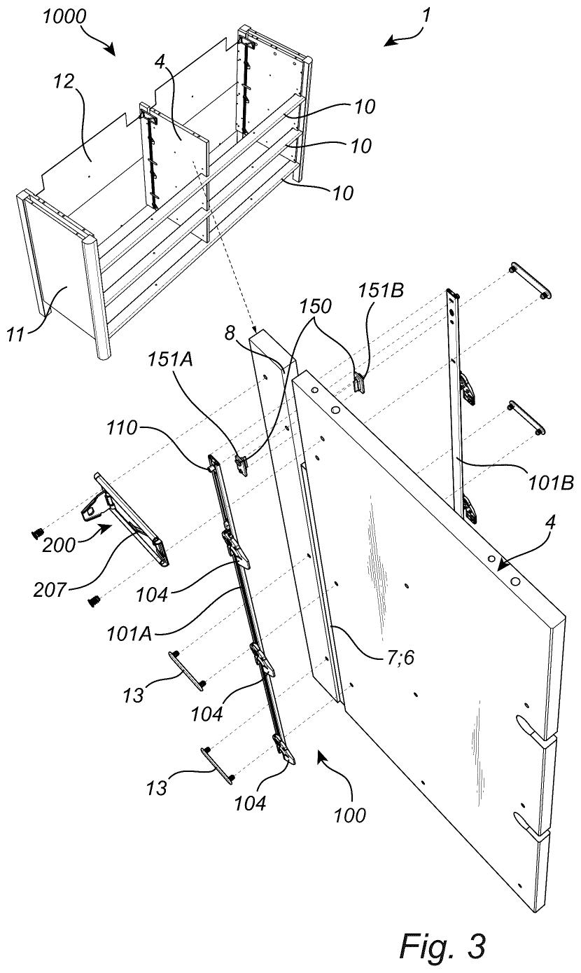

Starting with FIG. 1, one example of a chest of drawers 1 with two columns 2 of drawers 3 is disclosed. The two parallel columns 2 are vertically arranged and are separated inside the chest of drawers by a partition wall 4 (best seen in FIGS. 2 and 3). Each column 2 comprises in the disclosed embodiment two rows 5 with single drawers 3A and one row of two smaller drawers 3B arranged side by side. The two smaller drawers 3B are separated by a supplementary partition wall (not disclosed). The skilled person realizes that the two smaller drawers 3B may be replaced by a single drawer of the same type as that in the two other rows. The drawers 3A; 3B in one and the same column 2 may have different heights. Also, the columns 2 may comprise two or more drawers 3.

Unless nothing else is specifically given when discussing the invention in the following, the term “partition wall” refers to the partition wall 4, separating the two columns 2.

The principle of the invention to be discussed in detail below is equally applicable to a chest of drawers with three or more columns of drawers.

Turning to FIG. 2, one example of a partition wall 4 is disclosed. The partition wall 4 comprises a rear end 4A configured to face a rear wall of the chest of drawers 1 when mounted thereto, and a front end 4B configured to face a front end of the chest of drawers 1 when mounted thereto. The partition wall 4 has two opposing and identical major sides 6, whereby only one of the two sides is shown and discussed.

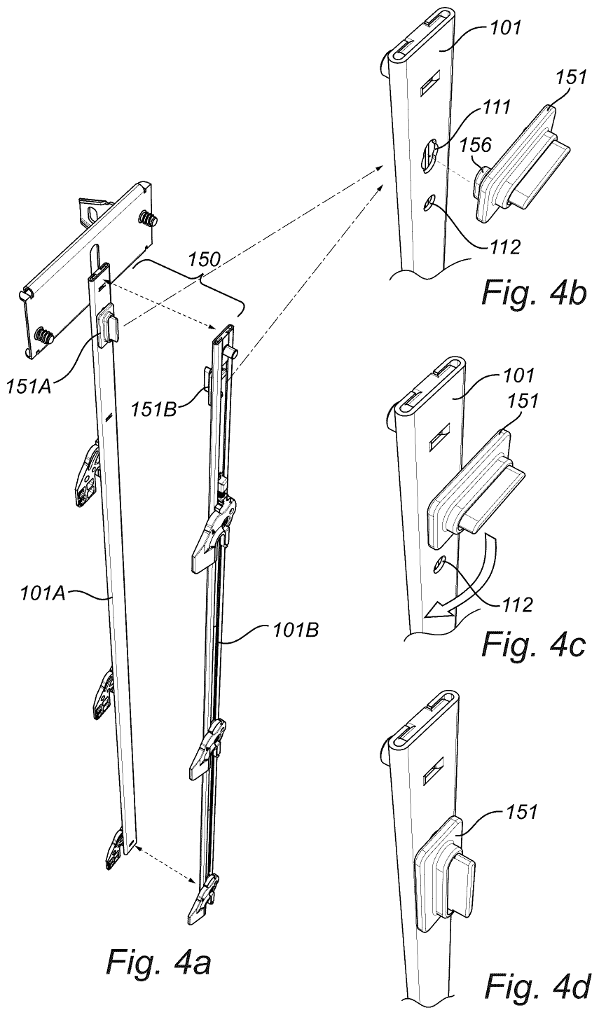

The rear end 4A of the partition wall 4 comprises a longitudinally extending groove 7. The upper end of the groove 7 merges with a throughgoing opening 8. The groove 7 is configured to slidingly receive a guiding rail forming part of a drawer locking arrangement 100 (to be described below). The throughgoing opening 8 is configured to receive a connector arrangement 150 (see FIGS. 4a-4d to be discussed below) that is configured to interconnect a first and a second guiding rail 101A, 101B that are to be arranged on the opposing major side wall portions 6 of the partition wall 4. The two guiding rails are part of the drawer locking arrangement 100.

The front end 4B of the partition wall 4 comprises two recesses 9. The recesses 9 are configured to receive a respective cross bar 10 (to be discussed below in view of FIG. 3), forming part of the chest of drawers 1.

Now turning to FIG. 3, a schematic exploded view of a chest of drawers 1 comprising an arrangement for tipping-over-prevention 1000 according to the invention is disclosed. The chest of drawers 1 comprises two side walls 11, the partition wall 4 and a rear wall 12. The top wall of the chest of drawers 1, the drawers and their respective sliders have been omitted to facilitate understanding. Three cross bars 10 extend on the front side and interconnects the side walls 11 and the partition wall 4.

The arrangement for tipping-over-prevention 1000 comprises a drawer locking arrangement 100 which comprises two guiding rails 101A, 101B. Each guiding rail 101A, 101B is configured to be movably received in the respective groove 7 in the two opposing sides 6 of the partition wall 4.

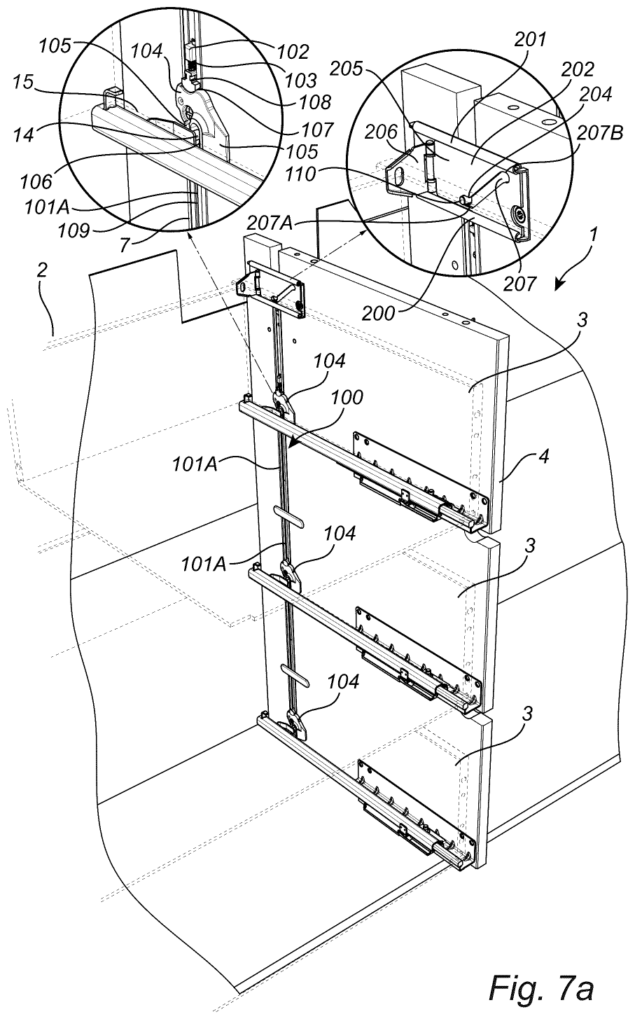

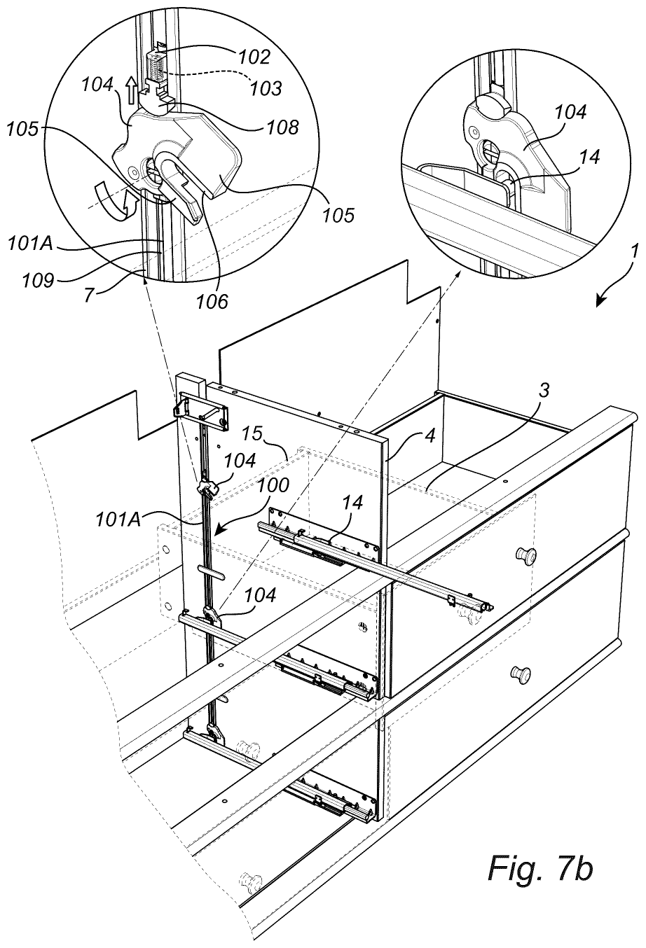

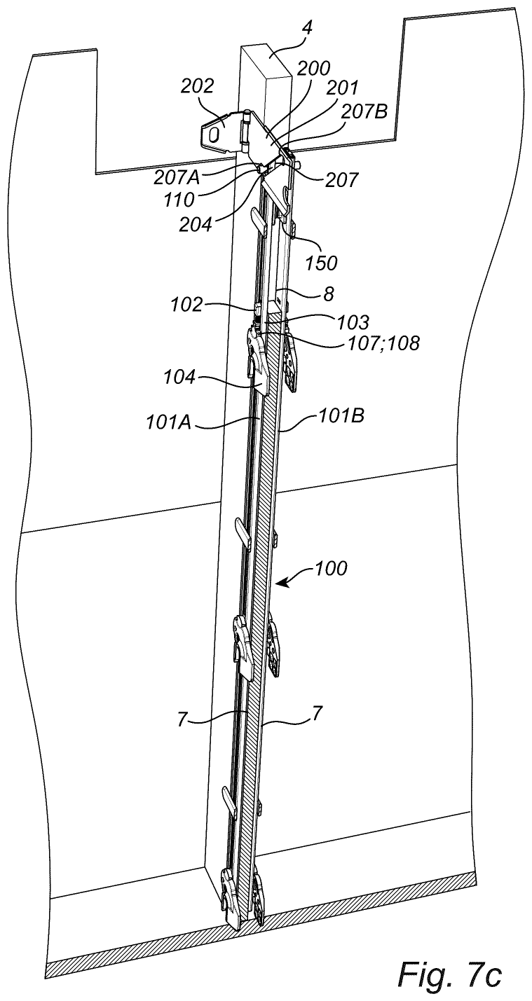

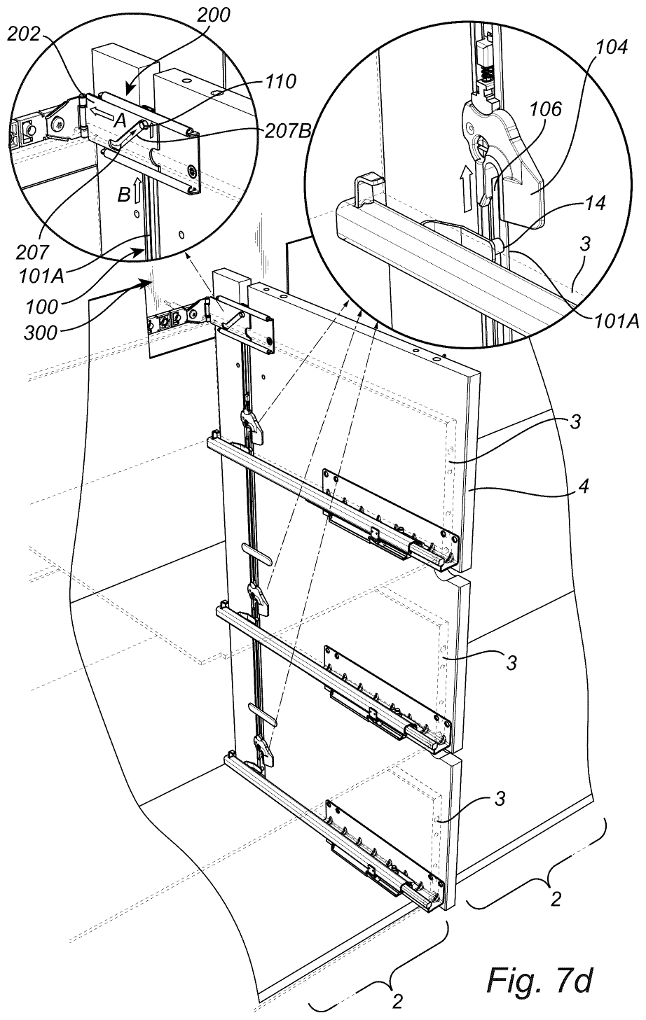

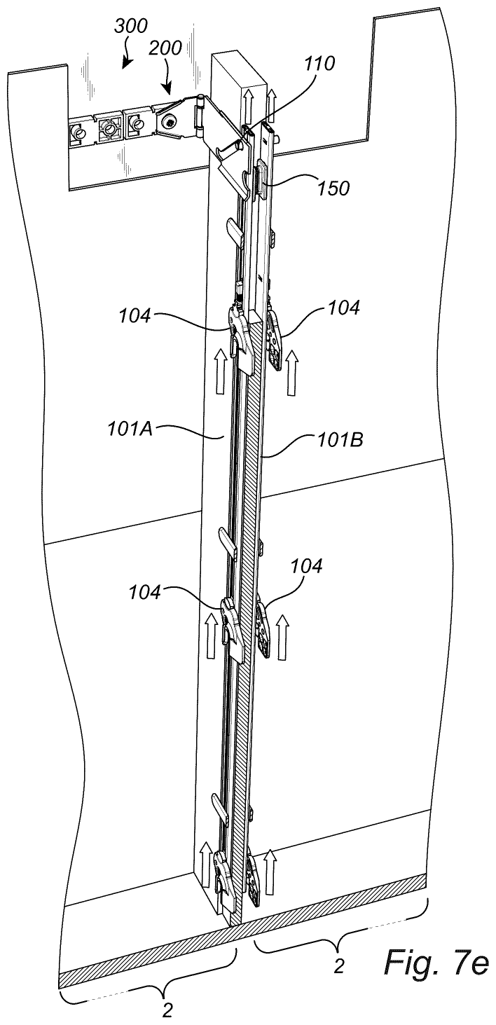

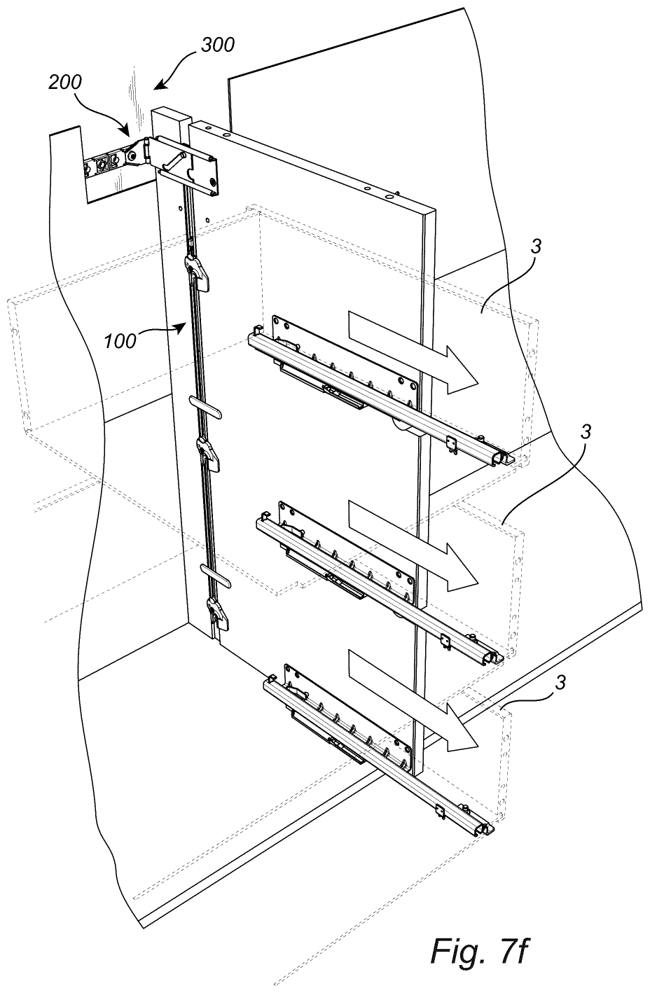

Each guiding rail 101A, 101B is configured to be movable by sliding in the respective groove 7. Each of the first and the second guiding rails 101A, 101B is disclosed as supporting three locking members 104. Each locking member 104 is configured to selectively engage an associated drawer as will be discussed below with reference to FIGS. 7a-7e.

The two guiding rails 101A, 101B are configured to be interconnected by a connector arrangement 150. The connector arrangement 150 is configured to interconnect the first and the second guiding rails 101A, 101B via the through-going opening 8 in the partition wall 4, whereby the first and second guiding rails 101A, 101B are configured to be moved by sliding along the grooves 7 as one common unit in view of the partition wall 4.

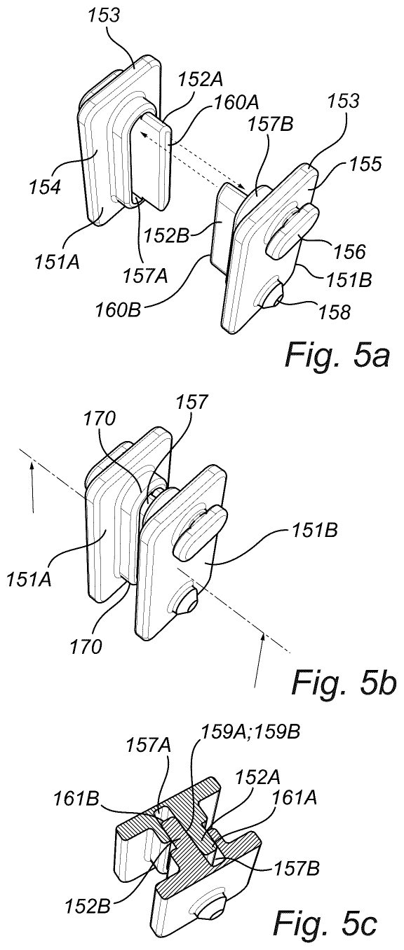

The connector arrangement 150 comprises a first connector member 151A configured to be mounted to the first guiding rail 101A and a second connector member 151B configured to be mounted to the second guiding rail 101B. Each of the first and second connector members 151A, 151B comprises a protrusion 152 (best seen in FIGS. 5a-5c) configured to engage the other of the first and second connector members 151A, 151B. The skilled person realizes that the connector members 151A, 151B may be arranged in a number of ways with remained functionality. In one very simple form (not disclosed), the connector members 151A, 151B may be provided by a bolt and nut.

The guiding rails 101A, 101B are slidingly maintained in their respective groove 7 by clamps 13. The clamps 13 are arranged to bridge the guiding rails 101A, 101B. The clamps 13 connect to the partition wall 4 by means of dowels or the like. The skilled person realizes that the guiding rails 101A, 101B may be slidingly maintained in the grooves 7 in a number of ways and that the clamps 13 may be arranged and designed in a number of ways with remained functionality.

At least one of the two guiding rails 101A comprises a driver 110 in its upper end. It is to be stressed that both guiding rails 101A, 101B may be provided with a driver 110, but only one of them will be used according to the invention. The driver 110, formed as a pin projecting away from the guiding rail, is configured to engage an anchoring bracket 200 that will be discussed below with reference to e.g., FIG. 4a. The anchoring bracket 200 is configured to be used when fixating the chest of drawers 1 to a structure separate from the chest of drawers 1. The structure 300 may by way of example be a wall of a building or another piece of furniture.

Now turning to FIGS. 4a-4d and FIG. 5a-5c, the mounting and functionality of one embodiment of the connector arrangement 150 will be explained. The connector arrangement 150 comprises, as given above, a first connector member 151A configured to be mounted to the first guiding rail 101A and a second connector member 151B configured to be mounted to the second guiding rail 101B. The first and second connector members 151A, 151B are identical, whereby only one connector member will be described in detail below. The connector members may be formed e.g. by injection molding of a plastic or composite material.

The connector member 151 comprises (best seen in FIG. 5a) a body 153 having a front side 154 and a rear side 155.

The rear side 155 comprises a T-shaped projection 156. The T-shaped projection 156 extends transverse to a longitudinal extension of the guiding rail to which it is intended to be mounted. It also extends transverse to a longitudinal extension of a protrusion 152 and a recess 157 which are arranged on the front side 154 of the body 153. The rear side 155 of the body further comprises a pin 158. The T-shaped projection 156 and the pin 158 are part of a snap-fit coupling that is used when mounting the connector member 151 to the guiding rail 101, as is illustrated in FIGS. 4a-4d.

As is best seen in FIG. 4b, the upper end of the guiding rail 101 comprises a through-going opening 111 with a cross-sectional profile that corresponds to the T-shaped projection 156. The guiding rail 101 further comprises a hole 112 or dent with a cross sectional profile corresponding to the pin 158 of the connector member 151.

The connector member 151 is configured to be mounted to the guiding rail 101 by the snap-fit coupling, where the T-shaped projection 156 is inserted into the through-going opening 111 in the guiding rail 101, see FIG. 4b. The connector member 151 is then turned 90 degrees, see FIG. 4c, into a position, see FIG. 4d, where the pin 158 is received in the corresponding hole 112 or dent in the guiding rail 101. The connector member 151 is fixedly connected to the guiding rail 101 in this position to such extent that it cannot be unintentionally rotated or removed. The skilled person realizes that the snap-fit coupling may be arranged in a number of ways with remained function. The disclosed embodiment should hence only be considered as a non-limiting embodiment.

The front side 154 of the connector member 151, see FIG. 5a, comprises an elongated protrusion 152 and a complementary elongated recess 157. The protrusion 152 and the recess 157 are arranged side by side. The recess 157 has an inner cross sectional-geometry that corresponds to an outer cross-sectional geometry of the protrusion 152. This allows the two connector members 151A, 151B to be moved towards each other, see FIGS. 5b and 5c, into a condition where a free end 160A of the protrusion 152A of the first connector member 151A engages the recess 157B in the second connector member 151B, and a free end 160B of the protrusion 152B of the second connector member 151B engages the recess 157A in the first connector member 151A.

The protrusions 152A, 152B of the first and second connector members 151A, 151B (best seen in FIG. 5c) each comprises an abutment surface 159A, 159B. The abutment surfaces 159A, 159B are configured to abut each other in a condition when the free end 160A of the first protrusion 152A engages the recess 157B in the second connector member 151B and when the free end 160B of the second protrusion 152B engages the recess 157A in the first connector member 151A. The abutment surfaces 159A, 159B are disclosed as being flat. It is to be understood that the abutment surfaces may be provided with friction means or linear guiding means.

The recesses 157A, 157B in the first and second connector members 151A, 151B may have a wedge-shaped cross section as seen in a direction transverse a longitudinal extension of the respective guiding rails 101A, 101B. Alternatively, the first and second protrusions 152A, 152B may each have a wedge-shaped cross section as seen in a direction transverse the longitudinal extension of the respective guiding rails 101. A wedge shape, no matter if it is the recesses or the protrusions, allows the provision of an enhanced locking effect between the first and second connector members 151A, 151B.

The recesses 157 in the connector members 151 comprises a wall portion 170 having an extension transverse the longitudinal extension of the recess 157. It is preferred that the recess 157 has a wall portion 170 on both of its opposing ends. The wall portion(s) 170 serves as a natural stop that restricts a mutual displacement between the two connector members 151A, 151B in a direction transvers the longitudinal extension of the recess 157.

Now turning to FIG. 3, the upper end of at least one of the two guiding rails 101A, 101B comprises a driver 110. The driver 110 is formed as a pin that projects away from the guiding rail 101. The driver 110 in one of the two guiding rails 101A, 101B is configured to project into a guiding slot 207 that is formed in the anchoring bracket 200. The interaction between the driver 101 and the anchoring bracket 200 will be described below.

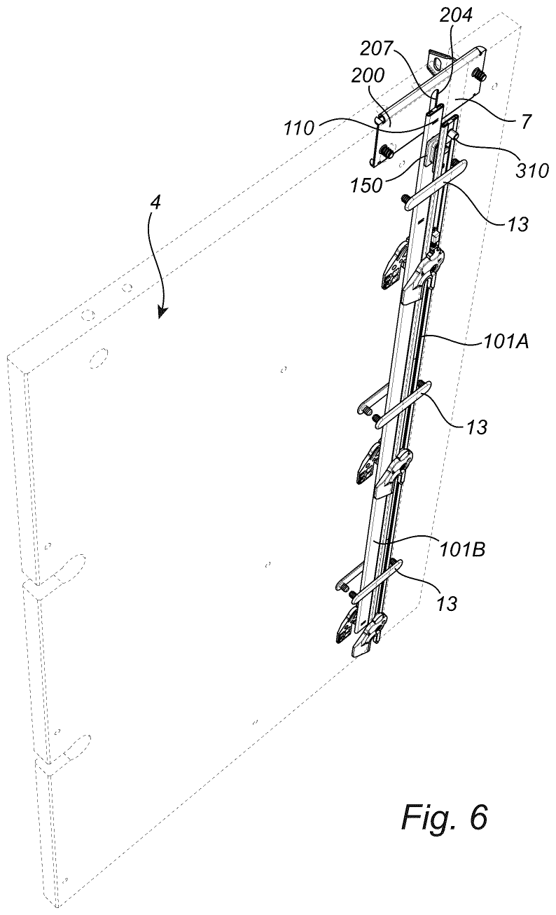

Now turning to FIG. 6, a partition wall 4 is schematically shown in a condition when the two guiding rails 101A, 101B have been mounted thereto together with the connector arrangement 150 that interconnects the two guiding rails 101A, 101B. The two guiding rails 101A, 101B are slidingly received in the two opposing groves 7 and will move as one common unit as a result of the connector arrangement 150. Also, the driver 110 of one of the two guiding rails 101A, 101B is received in the guiding slot 207 of the anchoring bracket 200. The two guiding rails 101A, 101B are maintained in their respective groove 7 by the clamps 13 that bridge the guiding rails 101A, 101B while being secured to the partition wall 4. It can also be seen that a rear wall portion of the anchoring bracket 200 is fixed to the partition wall, e.g., by screws or dowels.

Now turning to FIGS. 7a-7f, the interaction between the anchoring bracket 200 and one embodiment of an arrangement for a tipping-over-prevention 1000 using a locking arrangement 100 of the type that has been described above will be discussed. Three drawers 3 are disclosed highly schematically by dotted lines in the first column 2 to facilitate understanding.

Starting with FIG. 7a, the anchoring bracket 200 comprises a first bracket member 201 and a second bracket member 202. The second bracket member 202 is slidably received in the first bracket member 201. The first bracket member 201 is fixedly mounted to the partition wall 4. The partition wall 4 is preferably arranged to extend substantially perpendicular to a structure separate from the chest of drawers 1, such as a wall in a building or another furniture, to which the chest of drawers is to be anchored.

The first bracket member 201 comprises a throughgoing opening 204, see FIG. 6, having a longitudinal extension extending perpendicular to longitudinal extension of the first bracket member 201. The throughgoing opening 204 receives the driver 110 of the first guiding rail 101A.

The second bracket member 202 comprises a guiding portion 205 and a mounting portion 206. The second bracket member 202 is movable in relation to the first bracket member 201 between a first position and a second position, in which second position the second bracket member 202 is adapted to be anchored to a structure separate from the chest of drawers 1.

The second bracket member 202 comprises a V-shaped guiding slot 207 which is arranged to receive the driver 110 via the opening 204. The guiding slot 207 will together with the driver 110 form a cam mechanism which will be discussed below.

The V-shaped guiding slot 207 comprises a first slot portion 207a which has a longitudinal extension which coincides with the moving direction of the second bracket member 202 in view of the first bracket element 201. Further, the V-shaped guiding slot 207 comprises a second slot portion 207b forming an angle to the first slot portion 207a. The angle between the two slot portions has an impact on the force that is required to move the second bracket member to its second position. The larger the angle, the higher force is required.

Some drawer locking arrangements are well-known in the furniture industry. For example, a drawer locking arrangement is described in detail in U.S. Pat. No. 4,768,844 which is incorporated herein by reference. The drawer locking arrangement as described in said patent allows only one drawer at a time to be opened. Also, the drawer locking arrangement is fixedly mounted to a side wall of a chest of drawers.

In the present invention this is however not the case. Instead, the drawer locking arrangement 100 is according to the present invention slidingly mounted to the partition wall 4 of the chest of drawers 1 where the partition wall separates two columns 2 of drawers 3. In the disclosed embodiment, the two guiding rails 101A, 101B that form part of the arrangement for tipping-over-prevention 1000 according to the invention are received in respective vertically extending grooves 7 on the opposing sides of the partition wall 4. The two guiding rails 101 are interconnected by the connector arrangement 150 that has been described above with reference to FIGS. 4a-4d, 5a-5c and 6.

In the following the general working principle of the arrangement for tipping-over-prevention 1000 according to the invention will be described.

Starting with FIGS. 7a and 7b, the two guiding rails 101A, 101B are slidingly received in the two opposing grooves 7 and are interconnected by the connector arrangement 150 that extends through the through-going opening 8 in the partition wall 4. The anchoring bracket 200 is fixed to one of the two sides of the partition wall 4. Also, the anchoring bracket 200 is engaging the driver 110 that is arranged on the first guiding rail 101A. To be noted is that the drawers have been omitted in FIG. 7b to facilitate understanding.

Each guiding rail 101A, 101B, best seen in FIG. 7a, comprises a stop member 102 which is arranged in an upper end portion of the guiding rail 101. The stop member 102 comprises a spring 103 that is compressible a pre-determined distance in view of the stop member 102, which distance is limited to allow only one drawer at a time to be opened.

Each guiding rail 101A, 101B supports one locking member 104 per drawer 3 in the chest of drawers 1. In the disclosed embodiment, the arrangement for tipping-over-prevention 1000 is configured to be used for a chest of drawers 1 containing three drawers 3 in each column 2, and hence each guiding rail 101A, 101B supports three locking members 104. Each locking member 104 is pivotable supported on the guiding rail.

Each locking member 104 comprises two fingers 105 which between them define a gap 106 which is configured to receive an actuator pin 14 that is mounted to an exterior side wall portion 15 of each drawer 3. In a position when the drawers 3 are closed, see FIG. 7a, the actuator pin 14 will be received in said gap 106. The actuator pin 14 is allowed to enter the gap 106 when the drawer 3 is first inserted into the chest of drawers 1.

When pulling a drawer 3 to open the same, the actuator pin 14 will cause the locking member 104 to pivot, whereby the engagement between the actuator pin 14 and the fingers 105 will be released, thereby allowing the drawer 100 to be pulled out.

An upper edge portion of the respective locking member 104, best seen in FIG. 7a, comprises a cam surface 107 which is configured to interact with a cam shaped pusher 108. In the disclosed embodiment, the upper most pusher 108 is arranged to interact with the spring 103 of the stop member 102, whereas the subsequent pushers 108 are each indirectly interacting with spring 103 of the stop member 102 via rods 109 that are slidingly received in the guiding rail 101. Thus, when pivoting any of the locking members 104 below the upper most locking member 104, the rod or rods 109 of the one or more locking members 104 above the pivoted locking member 104 will be pushed upwardly to thereby act on the spring 103 of the stop member 102 to compress the same. As a result of the cam mechanism between the respective pusher 108 and the cam surface 107, the total compression length of the spring 103 of the stop member 102 will be the same no matter which locking member 104 is pivoted. By the limited allowed compression of the spring 103 allowed by the stop member 102, only one drawer at the time is allowed to be opened. This is illustrated in FIG. 7b.

FIG. 7b illustrates a state where the top drawer has been pulled out of the chest 1. The locking member 104, engaging with the top drawer in the closed state (FIG. 7a), has been pivoted in a counterclockwise direction due to the actuator pin 14 pushing on a surface of one of the fingers 105 when the drawers is pulled out. The pivoting of the locking member 104 has caused the pusher 108 to be displaced upwards, in an essential vertical direction shown by an arrow in FIG. 7b, by means of the cam surface 107. The cam surface 107 has pushed the pusher 108 and compressed the spring 103 against the stop member 102. The locking member 104 stays in the position illustrated in FIG. 7b until the drawer is pushed back in again and the actuator pin 14 is received by the gap 106 of the locking member 104 making the locking member 104 to pivot back to its starting position as the drawer moves into a completely closed state. When the drawer is in the completely closed state again the spring 103 is again in its decompressed state against the stop member 102 allowing another drawer to be opened.

As explained above, when one drawer is in an open position no other drawer can be opened, since the spring cannot be compressed further other locking member 104 are not able to displace its associated pusher 108 upwards and rotate to open.

As given above, at least the first guiding rail 101A comprises a driver 110 in the form of a pin that is fixedly arranged to the guiding rail.

As a result of the guiding rails 101 being slidably mounted to the partition wall 4 and by the connector arrangement 150 that interconnects the two guiding rails 101A, 101B, both guiding rails 101 will be displaced up and down along the grooves ‘7 by lifting the driver 110. Accordingly, by displacing the two guiding rails 101A, 101B upwardly in their respective grooves 7 by lifting the driver 110 a distance that exceeds an engagement length of the fingers 105 of the respective locking member 104, the locking function of the drawer locking arrangements 100 in both columns 2 will be set aside. Thus, the fingers 105 will no longer engage any actuator pin 14 of any drawer 100. Thereby any number of drawers 3 in both columns 2 may be selectively opened at the same time.

The second bracket member 202 of the anchoring bracket 200 is in FIGS. 7a-7c disclosed as being set in its default position in which it is biased towards a first position where the driver 110 is in a first driver position where it is received in the first slot portion 207a of the guiding slot 207. The drawer locking arrangement's 100 ordinary operation is thereby not affected whereby the drawer locking arrangement 100 has its ordinary intended function allowing only one drawer 3 at a time to be opened. Hence, the stop member 102 with its spring 103 is, just as described above, in a position where the actuator pins 14 of the respective drawers 100 are received in the gaps 106 that are formed between the two fingers 105 of the respective locking members 104.

It should be noted that in the shown examples, the pushers 108 of the first guiding rail 101A are not connected with corresponding pushers 108 of the second guiding rail 101B. Hence, if one drawer of a first column is opened thereby preventing the remaining drawers of the same column to open, one drawer of the second column may still be allowed to open. In other example, it is possible that pushers 108 of the two guiding rails 101A, 101B are connected such that movement of one pusher 108, due to one drawer being opened, will cause a corresponding vertical motion of the corresponding pusher 108 of the other guiding rail 101B even though all drawers of the second column are closed. In such examples, only one drawer of the entire chest of drawers can be opened.

Now turning to FIGS. 7d-7f the operation of the anchoring bracket 200 in combination with the locking arrangement 100 will be explained.

The drawers 3 are all set to a fully closed position. The anchoring bracket 200 is fixedly mounted to one side wall of the partition wall 4. To anchor the chest of drawers 1 to the structure 300 behind the chest of drawers, the second bracket member 202 of the anchoring bracket 200 is displaced towards the structure 300, see arrow A. During this displacement, the driver 110 that is attached to the first guiding rail 101A will be forced by the guiding groove 207 of the anchoring bracket 200 to lift both guiding rails 101A, 101B along the longitudinal extension of the grooves 7 in the partition wall 4, see arrow B. This lifting will also cause all locking members 104 to be displaced the same distance since they are supported by the two lifted guiding rails 101A, 101B.

The second bracket member 202, when set towards the second position to thereby anchor the chest of drawers 1, will be moved along a direction that is transvers to the longitudinal extension of the guiding rails 101A, 101B so that its mounting portion 206 is arranged into a flat abutting relationship with the structure 300 to which it should be anchored. The anchoring can be made by suitable screws.

The second bracket member 202 has in this position been displaced to such extent along the first bracket member 201 that the driver 110 has been displaced along the second slot portion 207b into a second driver position. In this second driver position, the anchoring bracket 200 has displaced both guiding rails 101A, 101B in the vertical direction to such extent that the actuator pins 14 of the drawers 3 are no longer received in the gaps 106 between the fingers of the locking members 104. Thus, two or more or all drawers 3 in both columns 2 may now be selectively opened. Thus, the anchoring bracket 200 is set to its position in which the functionality of the drawer locking arrangement 100 is set aside allowing any drawer or any number of drawers to be selectively opened, see FIG. 7f.

Accordingly, an arrangement for tipping-over-prevention 1000 is provided that is designed for a chest of drawers 1 with at least two columns 2 of drawers 3 where two adjacent columns 2 are separated by a partition wall 4. Each column 2 is provided with a drawer locking arrangement 100 that, by the use of at least two locking members 104 in each locking arrangement selectively allows only one drawer in a column to be opened at a time. The connector arrangement 150 that interconnects the first and second guiding rails 101A, 101B forces the two guiding rails 101 to be moved as one common unit. This allows the arrangement for tipping-over-prevention 1000 to be operated by one single mechanism that moves the two guiding rails 101A, 101B and hence the locking members 104 supported by the guiding rails 101 as one unit. Since this mechanism can be operated by one single anchoring bracket, the installation work by the end consumer is greatly facilitated and the number of holes that need to be made in the structure behind the chest of drawers can be substantially reduced. Also, an overall cost saving may be provided by a reduced number of parts.

It is to be understood that the arrangement according to the invention with one arrangement for tipping-over-prevention arranged in the partition wall may be supplemented with additional anchoring brackets to be arranged in the two opposite side walls 11 of the chest of drawers 1. These anchoring brackets may be any type of anchoring brackets.

The chest of drawers has been exemplified as comprising two columns. The principle is equally applicable to a chest of drawers comprising three or more columns. In the event of three columns, a partition wall separating two adjacent columns may be provided with an arrangement for tipping-over-prevention of the type described above according to the invention, whereas the opening of drawers in the third column may be controlled by an arrangement for tipping-over-prevention of the same type but that only comprises a single guiding rail with locking members and one anchoring bracket. Such extra guiding rail and anchoring bracket may be of the same type as that described above. It is also possible to omit the drawer locking arrangement in the third column and if necessary use a conventional anchoring bracket only. In the event of four columns separated by two partition walls, each partition wall may be provided with an arrangement for tipping-over-prevention according to the invention.

The invention is further disclosed by the following item list as defined by the below numbered items.

Item 1. Arrangement for tipping over prevention (1000) of a chest of drawers (1) comprising a partition wall (4) separating two columns (2) of drawers (3), wherein the arrangement comprises:
a first drawer locking arrangement (100) comprising a first guiding rail (101A) configured to be movably mounted to a first side of the partition wall (4), and
a second drawer locking arrangement (100) comprising a second guiding rail (101B) configured to be movably mounted to a second side of the partition wall (4), opposite the first side, wherein
each of the first and the second guiding rails (101A; 101B) supports at least two locking members (104), each locking member (104) being configured to selectively engage an associated drawer (3), and selectively allow only one drawer (3) in a column (2) to be opened at a time; and
a connector arrangement (150) configured to interconnect the first and the second guiding rails (101A; 101B) via a through-going opening (8) in the partition wall (4), whereby the first and second guiding rails (101A; 101B) are configured to be moved as one common unit in view of the partition wall (4).

Item 2. The arrangement according to item 1, wherein the connector arrangement (150) comprises a first connector member (151A) configured to be mounted to the first guiding rail (101A) and a second connector member (151B) configured to be mounted to the second guiding rail (101B), wherein one or both of the first and second connector members (151; 151B) comprises a protrusion (152A; 152B) configured to engage the other of the first and second connector members (151A; 151B).

Item 3. The arrangement according to item 2, wherein a free end of the protrusion (152A) of the first connector member (151A) is configured to engage a recess (157B) in the second connector member (151B), and wherein a free end of the protrusion (152B) of the second connector member (151B) is configured to engage a recess (157A) in the first connector member (151A).

Item 4. The arrangement according to item 3, wherein the protrusions (152A; 152B) of the first and second connector members (151A; 151B) each comprises an abutment surface (159), and wherein the abutment surfaces (159) are configured to abut each other in a condition when the free end of the first protrusion (152A) engages the recess (157B) in the second connector member (151B) and when the free end of the second protrusion (152B) engages the recess (157A) in the first connector member (151A).

Item 5. The arrangement according to item 4, wherein the recesses (157A; 157B) in the first and second connector members (151A; 151B) have a wedge-shaped cross section as seen in a direction transverse a longitudinal extension of the respective guiding rails (101A; 101B); and/or wherein the first and second protrusions (152A; 152B) each have a wedge-shaped cross section as seen in a direction transverse the longitudinal extension of the respective guiding rails (101A; 101B).

Item 6. The arrangement according to any of items 3-5, wherein the recesses (157A; 157B) in the first and second connector members (151A; 151B) each comprises a wall portion (160) having an extension transverse the longitudinal extension of the first and second guiding rails (101A; 101B).

Item 7. The arrangement according to item 3, wherein the first and second connector members (151A; 151B) are configured to be mounted to the respective guiding rail (101A; 101B) by a snap-fit coupling.

Item 8. The arrangement according to any of the preceding items, wherein the first and second connector members (151A; 151B) are prevented from being rotated when mounted to the respective guiding rail (101A; 101B).

Item 9. The arrangement according to any of the preceding items, wherein the first guiding rail (101A) comprises a driver (110) configured to engage an anchoring bracket (200); whereby
a mounting of the anchoring bracket (200) to a wall structure is configured to move the first and second guiding rails (101A; 101B) concurrently from a first position in which the at least two locking members (104) of the first and second drawer locking arrangements (100A; 100B) are set to allow opening of one drawer (5) per column only, into a second position in which the at least two locking members (104) of the drawer locking arrangements (100A; 100B) are set in a position in which all drawers (5) in both columns (2) are allowed to be selectively opened.

Item 10. The arrangement according to item 9, wherein the anchoring bracket (200) comprises a first bracket member (201) which is adapted to be mounted to the partition wall (4) of the chest of drawers (1) and a second bracket member (202) which is operatively engaging the driver (110) and which is movable in relation to the first bracket member (201) between a first position and a second position, in which second position the second bracket member (202) is adapted to be fixedly anchored to a structure (300) separate from the chest of drawers (1), whereby
when the second bracket member (202) is in its first position, the driver (110) is set to a first driver position in which the at least two locking members (104) of the drawer locking arrangements (101A; 101B) are set to allow opening of one drawer (5) per column (2) only, and
when the second bracket member (202) is in its second position, the driver (110) is set into a second driver position in which the at least two locking members (104) of the drawer locking arrangements (101A; 101B) are set in a position in which all drawers (5) are allowed to be selectively opened.

Item 11. A chest of drawers comprising a partition wall (4) separating two columns (2) of drawers (3), and which comprises an arrangement (1000) for tipping over prevention according to any of claims 1-10.

1. An arrangement for tipping-over-prevention of a chest of drawers that includes a partition wall separating two columns of drawers, the arrangement comprising:
a first drawer locking arrangement having a first guiding rail configured to be movably mounted to a first side of the partition wall;
a second drawer locking arrangement having a second guiding rail configured to be movably mounted to a second side of the partition wall, opposite the first side;
a plurality of locking members;
wherein each of the first and the second guiding rails supports at least two of the locking members, each locking member being configured to selectively engage an associated drawer, and selectively allow only one drawer in a column to be opened at a time; and
a connector arrangement configured to interconnect the first and the second guiding rails via a through-going opening in the partition wall, such that the first and the second guiding rails are configured to be moved as one common unit relative to the partition wall.

2. The arrangement according to claim 1, wherein each locking member is pivotally supported on the associated guiding rail;
wherein each locking member has a gap configured to receive an actuator pin of an associated drawer.

3. The arrangement according to claim 2, wherein each locking member is pivotable between a first position, in which the actuator pin is held in place by the gap, and a second position, in which the actuator pin is free to move away from the gap.

4. The arrangement according to claim 3, further comprising at least one rod being configured to move between an idle position, in which each locking member is allowed to pivot from the first position to the second position, and a lifted position, in which each locking member is prevented to pivot from the first position to the second position.

5. The arrangement according to claim 4, wherein a first locking member pivoting from the first position to the second position causes the at least one rod to move from the idle position to the lifted position.

6. The arrangement according to claim 1, wherein the connector arrangement comprises:
a first connector member configured to be mounted to the first guiding rail; and
a second connector member configured to be mounted to the second guiding rail;
wherein one or both of the first and the second connector members includes a protrusion configured to engage the other of the first and the second connector members.

7. The arrangement according to claim 6, wherein a free end of the protrusion of the first connector member is configured to engage a recess in the second connector member; and
wherein a free end of the protrusion of the second connector member is configured to engage a recess in the first connector member.

8. The arrangement according to claim 7, wherein the protrusions of the first and the second connector members each comprises an abutment surface; and
wherein the abutment surfaces are configured to abut each other in a condition when the free end of the protrusion of the first connector member engages the recess in the second connector member and when the free end of the protrusion of the second connector member engages the recess in the first connector member.

9. The arrangement according to claim 8, wherein the recesses in the first and the second connector members have a wedge-shaped cross section as seen in a direction transverse a longitudinal extension of the respective guiding rails; and/or
wherein the protrusions of the first and the second connector members have a wedge-shaped cross section as seen in a direction transverse to the longitudinal extension of the respective guiding rails.

10. The arrangement according to claim 7, wherein the recesses in the first and the second connector members each comprises a wall portion having an extension transverse to a longitudinal extension of the first and the second guiding rails.

11. The arrangement according to claim 7, wherein the first and the second connector members are configured to be mounted to the respective guiding rail by a snap-fit coupling.

12. The arrangement according to claim 6, wherein the first and the second connector members are rotationally fixed to the respective guiding rail.

13. The arrangement according to claim 1, further comprising an anchoring bracket;
wherein the first guiding rail comprises a driver configured to engage the anchoring bracket;
wherein a mounting of the anchoring bracket to a wall structure is configured to move the first and the second guiding rails concurrently from a first position in which the at least two locking members of the first and the second drawer locking arrangements are set to allow opening of one drawer per column only, into a second position in which the at least two locking members of the first and the second drawer locking arrangements are set in a position in which all drawers in both columns are allowed to be selectively opened.

14. The arrangement according to claim 13, wherein the driver is configured to move the guiding rails from the first position, in which the locking members engage with the associated drawers, to the second position, in which the locking members are disengaged from the associated drawers.

15. The arrangement according to claim 13, wherein the anchoring bracket comprises:
a first bracket member which is adapted to be mounted to the partition wall of the chest of drawers; and
a second bracket member which is operatively engaging the driver and which is movable in relation to the first bracket member between a first position and a second position, in which second position the second bracket member is adapted to be fixedly anchored to a structure separate from the chest of drawers;
wherein, when the second bracket member is in its first position, the driver is set to a first driver position in which the at least two locking members of the first and the second drawer locking arrangements are set to allow opening of one drawer per column only; and
wherein, when the second bracket member is in its second position, the driver is set into a second driver position in which the at least two locking members of the first and the second drawer locking arrangements are set in a position in which all drawers are allowed to be selectively opened.

16. An arrangement for tipping-over-prevention of a chest of drawers that includes a partition wall separating two columns of drawers, the arrangement comprising:
a first guiding rail movably mounted to a first side of the partition wall;
a second guiding rail movably mounted to a second side of the partition wall;
wherein each of the first and the second guiding rails supports a plurality of locking members that are respectively engageable with associated drawers;
wherein the first and the second guiding rails are movable relative to the partition wall between,
a first lowered position in which all of the locking members are respectively engaged with the associated drawers in a closed condition, and
a second elevated position in which all of the locking members are respectively disengaged from the associated drawers in the closed condition.

17. The arrangement according to claim 16, further comprising:
a connector arrangement interconnecting the first and the second guiding rails via a through-going opening in the partition wall (4), such that the first and the second guiding rails (101A, 101B) are movable as one common unit relative to the partition wall (4).

18. An arrangement for tipping-over-prevention of a chest of drawers that includes a partition wall separating two columns of drawers, the arrangement comprising:
a first guiding rail movably mounted to a first side of the partition wall;
a second guiding rail movably mounted to a second side of the partition wall;
wherein each of the first and the second guiding rails supports a plurality of locking members that are respectively engageable with associated drawers;
wherein the first and the second guiding rails are interconnected and movable relative to the partition wall between,
a first position in which only one drawer of each column of drawers is allowed to open at a time, and
a second position in which any number of drawers of each column of drawers are allowed to be open at a time.

19. A chest of drawers comprising a partition wall separating two columns of drawers, and an arrangement for tipping-over-prevention according to claim 1.
